(19) United States
(12) Patent Application Publication
(10) Pub. No.: US 2011/0224914 A1
(43) Pub. Date: Sep. 15, 2011

(54) CONSTRAINED PROCESSING TECHNIQUE FOR AN IMPEDANCE BIOSENSOR

(75) Inventor: Dean Messing, Camas, WA (US)

(73) Assignee: Sharp Laboratories of America, Inc., Camas, WA (US)

(21) Appl. No.: 13/070,096

(22) Filed: Mar. 23, 2011

Related U.S. Application Data
(63) Continuation-in-part of application No. 12/785,179, filed on May 21, 2010.
Application No. 12/785,179 is a continuation-in-part of application No. 12/661,127, filed on Mar. 10, 2010.

(51) Int. Cl. G06F 19/00

(52) U.S. Cl. 702/19

(57) ABSTRACT

A system for determining impedance includes receiving a time varying voltage signal from a biosensor and receiving a time varying current signal from the biosensor. The time varying voltage signal and the time varying current signal are transformed to a domain that represents complex impedance values. Parameters based upon the impedance values are calculated using at least one constrained pole set to a DC value.

### CROSS-REFERENCE TO RELATED APPLICATIONS

This application is a continuation-in-part of U.S. patent application Ser. No. 12/785,179, filed May 21, 2010, which is a continuation-in-part of U.S. patent application Ser. No. 12/661,127, filed Mar. 10, 2010.

### BACKGROUND OF THE INVENTION

The present invention relates generally to signal processing for a biosensor.

A biosensor is a device designed to detect or quantify a biochemical molecule such as a particular DNA sequence or particular protein. Many biosensors are affinity-based, meaning they use an immobilized capture probe that binds the molecule being sensed—the target or analyte—selectively, thus transferring the challenge of detecting a target in solution into detecting a change at a localized surface. This change can then be measured in a variety of ways. Electrical biosensors rely on the measurement of currents and/or voltages to detect binding. Due to their relatively low cost, relatively low power consumption, and ability for miniaturization, electrical biosensors are useful for applications where it is desirable to minimize size and cost.

Electrical biosensors can use different electrical measurement techniques, including for example, voltammetric, amperometric/coulometric, and impedance sensors. Voltammetry and amperometry involve measuring the current at an electrode as a function of applied electrode-solution voltage. These techniques are based upon using a DC or pseudo-DC signal and intentionally change the electrode conditions. In contrast, impedance biosensors measure the electrical impedance of an interface in AC steady state, typically with constant DC bias conditions. Most often this is accomplished by imposing a small sinusoidal voltage at a particular frequency and measuring the resulting current; the process can be repeated at different frequencies. The ratio of the voltage-to-current phasor gives the impedance. This approach, sometimes known as electrochemical impedance spectroscopy (EIS), has been used to study a variety of electrochemical phenomena over a wide frequency range. If the impedance of the electrode-solution interface changes when the target analyte is captured by the probe, EIS can be used to detect that impedance change over a range of frequencies. Alternatively, the impedance or capacitance of the interface may be measured at a single frequency.

What is desired is a signal processing technique for a biosensor.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 illustrates a biosensor system for medical diagnosis.

FIG. 2 illustrates a noisy impedance signal and impedance model.

FIG. 3 illustrates a one-port linear time invariant system.

FIGS. 4A and 4B illustrate different pairs of DTFT functions.

FIG. 5 illustrates noisy complex exponentials.

FIG. 6 illustrates transmission zeros and poles.

FIG. 7 illustrates a noisy signal and true signal.

FIG. 8 illustrates multiple repetitions of FIG. 7.

FIGS. 9A and 9B illustrate accuracy for line fitting.

FIG. 10 illustrates an impedance graph.

FIG. 11 illustrates groups of specific binding and non-specific binding.

FIG. 12 illustrates aligned impedance responses.

FIG. 13 illustrates low concentration impedance response curves.

FIG. 14 illustrates estimation of analyte concentration.

FIG. 15 illustrates another estimation technique.

FIG. 16 illustrates yet another estimation technique.

### DETAILED DESCRIPTION OF PREFERRED EMBODIMENT

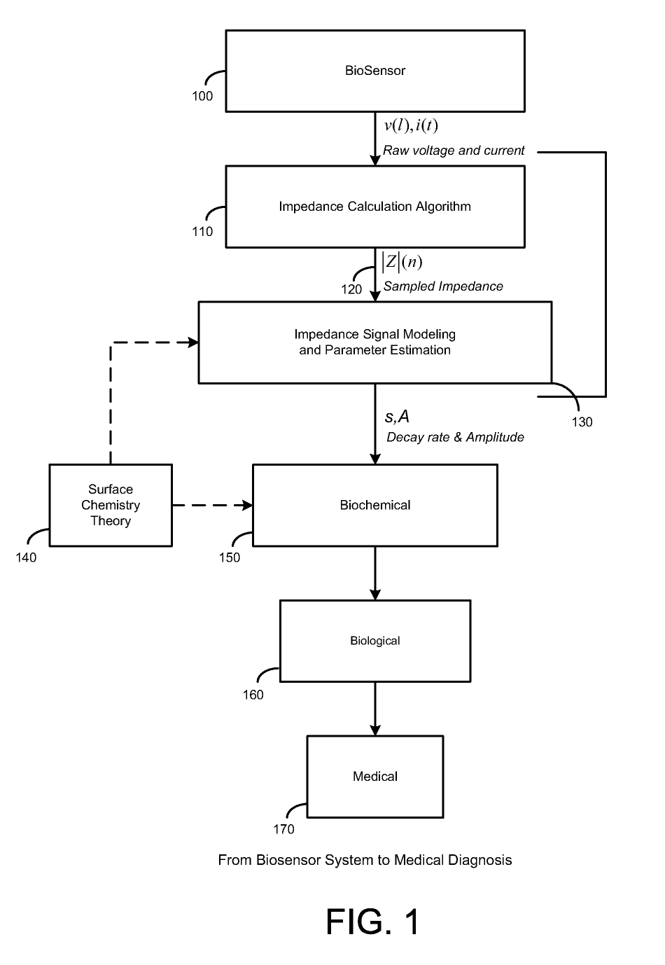

Referring to FIG. 1, the technique used during an exemplary medical diagnostic test using an impedance biosensor system as the diagnostic instrument is shown. The system includes a bio-functionalized impedance electrode and data acquisition system 100 for the signal acquisition of the raw stimulus voltage, v(t), and response current, i(t). Next, an impedance calculation technique 110 is used to compute sampled complex impedance, Z(n) as a function of time.

As illustrated in FIG. 1, the magnitude of the complex impedance, |Z(n)|, is shown as the output of the impedance calculation technique 110. Preferably, a parameter estimation technique 130 uses |Z|(n) 120 as its input. Real or imaginary parts, or phase of Z are also possible inputs to the parameter estimation technique 130. Following the computation of |Z|(n) 120, the parameter estimation technique 130 extracts selected parameters. Such parameters may include, for example, an amplitude “A”, and decay rate “s”. The amplitude and decay rate may be modeled according to the following relation:

|Z(n)|=B−Ae^{-sn} where s,A,B≧0 are preferably constants (equation 1),

derived from surface chemistry interaction 140. The constant B preferably represents the baseline impedance which may also be delivered by the parameter estimation technique. The surface chemistry theory 140 together with the results of the parameter estimation 130 may be used for biochemical analysis 150. The biochemical analysis 150 may include, for example, concentration, surface coverage, affinity, and dissociation. The result of the biochemical analysis 150 may be used to perform biological analysis 160. The biological analysis 160 may be used to determine the likely pathogen, how much is present, whether greater than a threshold, etc. The biological analysis 160 may be used for medical analysis 170 to diagnosis and treat.

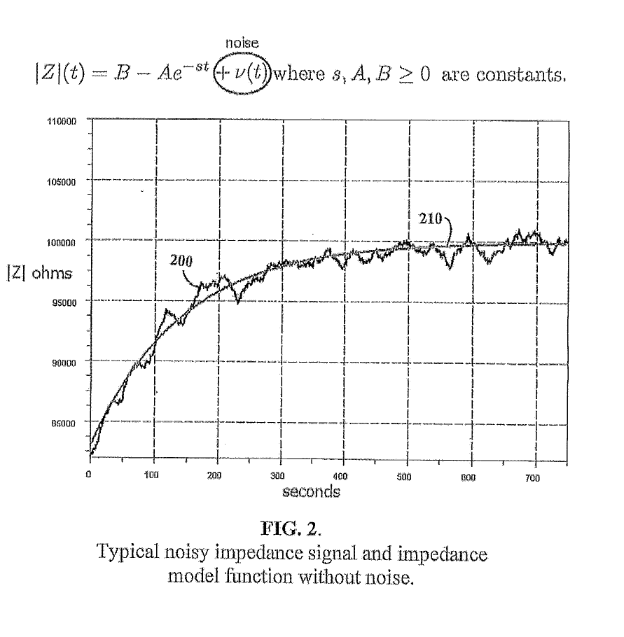

Referring to FIG. 2, an exemplary noisy impedance signal 200 is shown during analyte binding. The parameter estimation 130 receives such a signal as an input and extracts s, A, and B. From these three parameters, an estimate of the underlying model function may be computed from equation 1 using the extracted parameters. Such a model function is shown by the smooth curve 210 in FIG. 2. One of the principal difficulties in estimating these parameters is the substantial additive noise present in the impedance signal 200.

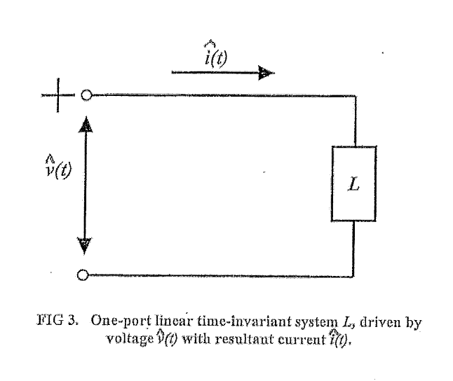

Over relatively short time periods, such as 1 second or less, the system may consider the impedance of the biosensor to be in a constant state. Based upon this assumption, it is a reasonable to approximate the system by a linear time invariant system such as shown in FIG. 3. Variables with a “hat” are complex valued, while the complex impedance is noted as Z. In some embodiments, for example, the system may be non-linear, time variant, or non-linear time variant.

One may presume that FIG. 3 is driven by the complex exponential voltage \hat{v}(t)=Âᵥe^{jw}^{₀}^{t} (equation 2) where Âᵥ is a complex number known as the complex amplitude of v(t), and ω₀ is the angular frequency of v(t) in rad/sec. The current through L will, again, be a complex exponential having the same angular frequency î(t)=Âᵢe^{jw}^{₀}^{t} (equation 3) where Âᵢ is the complex amplitude of î(t). The steady-state complex impedance Z of L at angular frequency ω₀ is defined to be the quotient \hat{v}(t)/î(t) when the driving voltage or current is a complex exponential of frequency ω₀. This definition does not hold for ordinary real-valued “physical” sinusoids. This may be observed, for example, from the fact that the denominator of v(t)/i(t) would periodically vanish if v(t) and i(t) are sine curves. Denoting Âᵥ=Aᵥe^{jθ} and Âₜ=Aᵢe^{jθ}, where Aᵥ=|Âᵥ| and Aᵢ=|Âᵢ| then Z becomes

$$Z = \frac{{A}_{v}}{{A}_{i}} {e}^{j ( φ - θ )} . \qquad ( equation 4 )$$

The impedance biosensor delivers sampled voltage and current from the sensor. It is noted that the sinusoidal (real-valued) stimulus voltage and response current can each be viewed as the sum of two complex exponential terms. Therefore to estimate the complex voltage and the complex current for calculating Z, the system may compute the discrete-time-Fourier-transform (“DTFT”) of each, where the DTFT of each is evaluated at a known stimulus frequency. If the stimulus frequency is not known, it may be estimated using standard techniques. Unfortunately, the finite time aperture of the computation and the incommensurability of the sampling frequency and the stimulus frequency can corrupt the estimated complex voltage and current values.

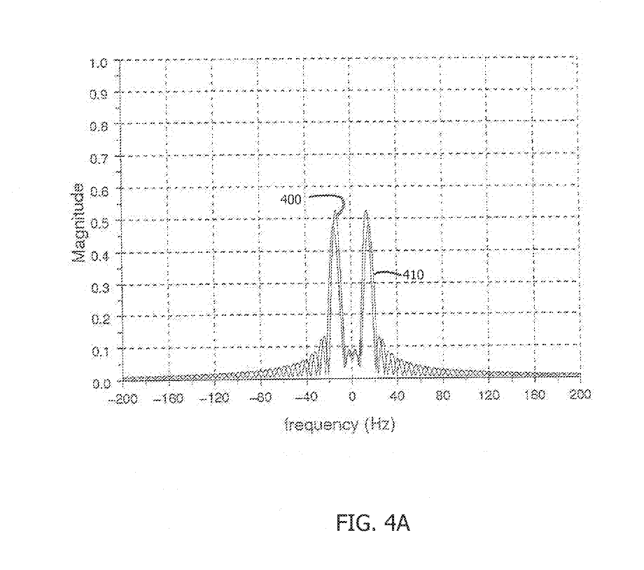

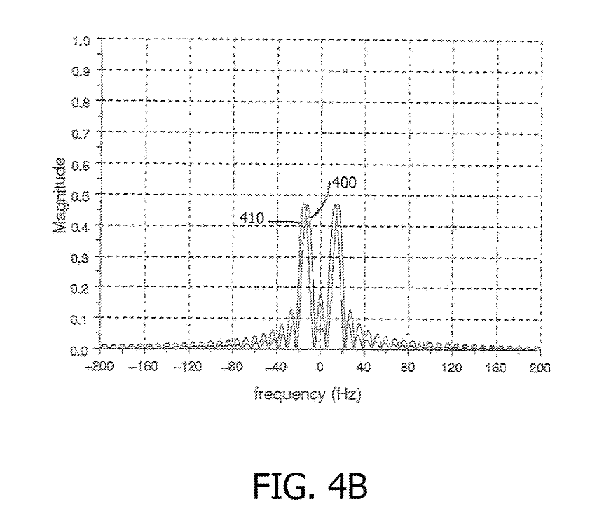

An example of these effects are shown in FIGS. 4A and 4B where the DTFT of two sinusoids having different frequencies and phases, but identical (unit) amplitudes are plotted. FIG. 4A illustrates a plot of the DTFT of a 17 Hz sinusoid 400 and a 19 HZ sinusoid 410. Each has the same phase, ψ. FIG. 4B illustrates a shifted phase of each to a new value ψ≠φ. It may be observed that the peak amplitudes of the DTFTs are different in one case and nearly the same in the other, yet the actual amplitudes of the sinusoids are unity in all cases.

A correction technique is used to determine the “true” value of the underlying peak from the measured value of the positive frequency peak together with the contribution of the negative frequency peak weighted by a value, such as the Dirichlet Kernel function associated with the time aperture. The result is capable of giving the complex voltage and current estimated values within less than 0.1% of their “true” values. Once the estimates of \hat{v} and î are found, Z is computed as previously noted.

The decay rate estimation technique may use any suitable technique. The preferred technique is a modified form of the general Kumaresan-Tufts (KT) technique to extract complex frequencies. In general, the KT technique assumes a general signal model composed of uniformly spaced samples of a sum of M complex exponentials corrupted by zero-mean white Gaussian noise, w(n), and observed over a time aperture of N samples. This may be described by the equation

$$y ( n ) = {\sum }_{k = 1}^{M} {α}_{k} {e}^{{β}_{k} n} + w ( n ) \\ n = 0 , 1 , … , N - 1. \qquad ( equation 5 )$$

βₖ=−sₖ+i2πfₖ are complex numbers (sₖ is non-negative) and αₖ are the complex amplitudes. The {βₖ} may be referred to as the complex frequencies of the signal. Alternatively, they may be referred to as poles. {sₖ} may be referred to as the pole damping factors and {fₖ} are the pole frequencies. The KT technique estimates the complex frequencies {βₖ} but not the complex amplitudes. The amplitudes {αₖ} are later estimated using any suitable technique, such as using Total Least Squares once estimates of the poles y(n) are obtained.

The technique may be summarized as follows.

(1) Acquire N samples of the signal, {y*(n)}ₙ₌₀^{N-1} to be analyzed, where y is determined using equation 5.

(2) Construct a L^{th} order backward linear predictor where M≦L≦N−M:
(a) Form a (N−L)×L Henkel data matrix, A, from the conjugated data samples {y*(n)}ₙ₌₁^{N-1}.
(b) Form a right hand side backward prediction vector h=[y(0), . . . , y(N−L−1)]^{H} (A is the conjugate transpose).
(c) Form a predictor equation.
   Ab=−h, where b=[b(1), . . . , b(L)]^{T} are the backward prediction filter coefficients. It may be observed that the predictor implements an L^{th} order FIR filter that essentially computes y(0) from y(1), . . . , y(N−1).
(d) Decompose A into its singular values and vectors: A=UΣV^{H}.
(e) Compute b as the truncated SVD solution of Ab=−h where all but the first M singular values (ordered from largest to smallest) are set to zero. This may also be referred to as the reduced rank pseudo-inverse solution.
(f) Form a complex polynomial B(z)=1+Σₗ₌₁^{L}b(l)z^{l} which has zeros at {e^{-B}^{ₖ}}ₖ₌₁^{M} among its L complex zeros. This polynomial is the z-transform of the backward prediction error filter.
(g) Extract the L zeros, {zₗ}ₗ₌₁^{L}, of B(z).
(h) Search for zeros, Zₗ, that fall outside or on the unit circle (1≦|zₗ|). There will be M such zeros. These are the M signal zeros of B(z), namely {e^{-B*}^{ₖ}}ₖ₌₁^{M}. The remaining L−M zeros are the extraneous zeros. The extraneous zeros fall inside the unit circle.
(i) Recover sₖ and 2πfₖ from the corresponding zₖ by computing Re[ln(zₖ)] and Im[ln(zₖ)], respectively.

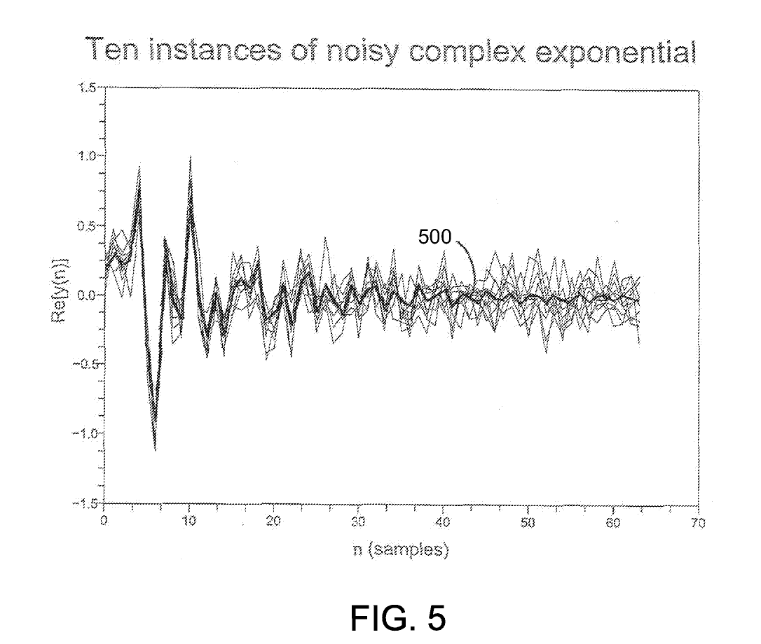

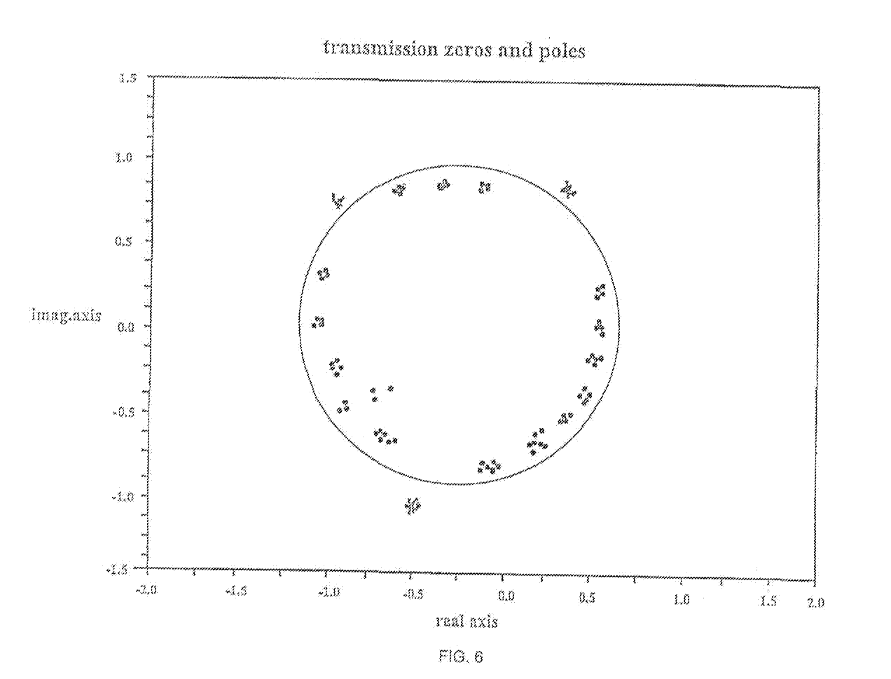

Referring to FIG. 5 and FIG. 6, one result of the KT technique is shown. The technique illustrates 10 instances of a 64-sample 3 pole noisy complex exponential. The noise level was set such that PSNR was about 15 dB. FIG. 5 illustrates the real part of ten signal instances. Overlaid is the noiseless signal 500.

FIG. 6 illustrates the results of running the KT technique on the noisy signal instances of FIG. 5. These results were generated with the following internal settings N=64, M=3, and L=18. The technique estimated the three single pole positions relatively accurately and precision in the presence of significant noise. As expected, they fall outside the unit circle while the 15 extraneous zeros fall inside.

As noted, the biosensor signal model defined by equation 1 accords with the KT signal model of equation 5 where M=2, β₁=0, β₂=−s. In other words, equation 1 defines a two-pole signal with one pole on the unit circle and the other pole on the real axis just to the right of (1,0).

On the other hand, typical biosensor impedance signals can have decay rates that are an order of magnitude or more smaller than those illustrated above. In terms of poles, this means that the signal pole location, s, is nearly coincident with the pole at (1,0) which represents the constant exponential term B.

The poles may be more readily resolved from one another by substantially sub-sampling the signal to separate the poles. By selecting a suitable sub-sampling factor, such as 8 or 16 before the decay rate estimation, the poles of the biosensor signal may be more readily resolved and their parameters extracted. The decay rate is then recovered by scaling the value returned from the technique by the sub-sampling factor.

The KT technique recovers only the {βₖ} in equation 5 and not the complex amplitudes {αₖ}. To recover the amplitudes, the parameter estimation technique may fit the model

$$y ( n ) = {\sum }_{k = 1}^{M} {α}_{k} {e}^{{\hat{β}}_{k} n} , \\ n = 0 , 1 , … , N - 1. \qquad ( equation 6 )$$

to the data vector {y(n)}ₙ₌₀^{N-1}. In equation 6, {\hat{β}ₖ} are the estimated poles recovered by the KT technique. The factors {e^{\hat{β}}^{ₖ}ⁿ} now become the basis function for ŷ(n), which is parametrically defined through the complex amplitudes {αₖ} that remain to be estimated. The system may adjust the {αₖ} so that ŷ(n) is made close to the noisy signal y(n). If that sense is least squares, then the system would seek {αₖ} such that ŷ(n)−y(n)=e(n) where the perturbation {e(n)} is such that ∥e∥₂ is minimized.

This may be reformulated using matrix notion as Sx=b+e (equation 7), where the columns of S are the basis functions, x is the vector of unknown {αₖ}, b is the signal (data) vector {y(n)}, and e is the perturbation. In this form, the least squares method may be stated as determining the smallest perturbation (in the least squares sense) such that equation 7 provides an exact solution. The least squares solution, may not be the best for this setting because the basis functions contain errors due to the estimation errors in the {\hat{β}ₖ}. That is, the columns of S are perturbed from their underlying true value. This suggests that a preferred technique is a Total Least Squares reformulation (S+E)x=b+e (equation 8) where E is a perturbation matrix having the dimensions of S. In this form, the system may seek the smallest pair (E,e), such that equation 8 provides a solution. The size of the perturbation may be measured by ∥E,e∥_{F}, the Frobenius norm of the concatenated perturbation matrix. By smallest, this may be the minimum Frobenius norm. Notice that in the context of equation 1, a₁=B, and a₂=−S.

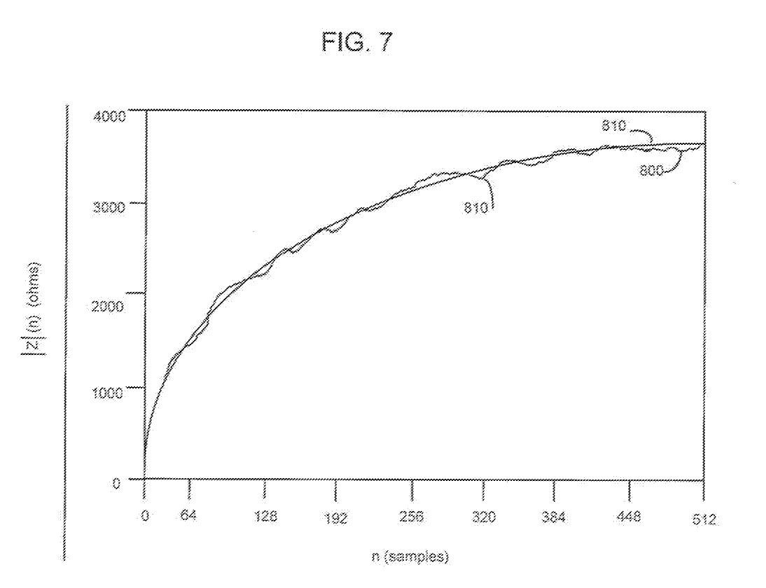

The accuracy of the model parameters, (s,A) is of interest. FIG. 7 depicts with line 800 the underlying “ground truth” signal used. It is the graph of equation 1 using values for (s,A), and B that mimic those of the acquired (noiseless) biosensor impedance response. The noisy curve 810 is the result of adding to the ground truth 800 noise whose spectrum has been shaped so that the overall signal approximates a noisy impedance signal acquired from a biosensor. The previously described estimation technique was applied to this, yielding parameter estimates (ŝ,Â), and \hat{B} from which the signal 820 of equation 1 was reconstituted. The close agreement between the curves 800 and 820 indicates the accuracy of the estimation.

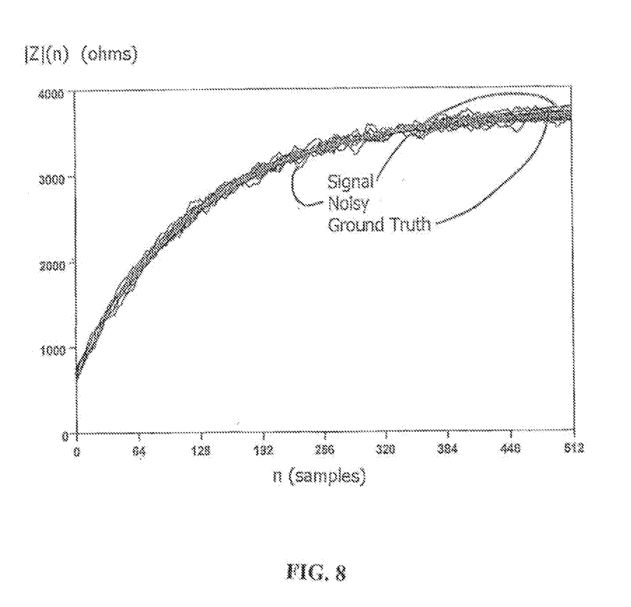

FIG. 8 illustrates applying this technique 10 times, using independent noise functions for each iteration. All the noisy impedance curves are overlaid, as well as the estimated model curves. Agreement with ground truth is good in each of these cases despite the low signal to noise ratio.

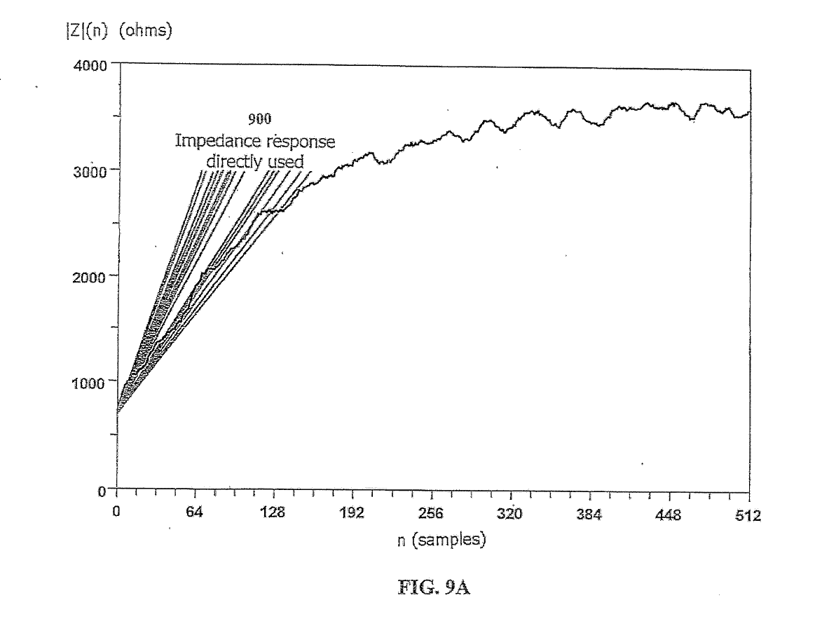

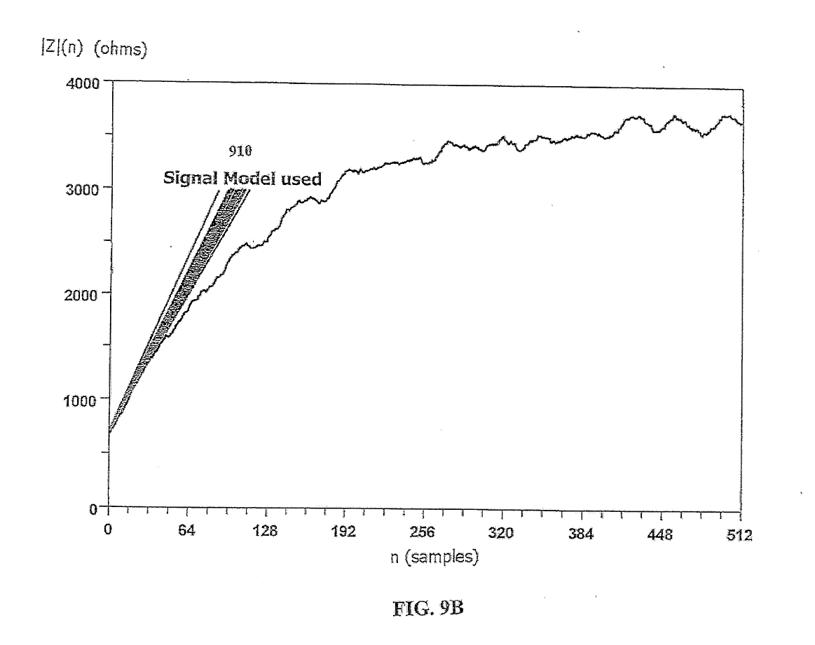

One technique to estimate the kinetic binding rate is by fitting a line to the initial portion of the impedance response. One known technique is to use a weighted line fit to the initial nine points of the curve. The underlying ground truth impedance response was that of the previous accuracy test, as was the noise. One such noisy response is shown in FIGS. 9A and 9B. Each of the 20 independent trials fitted a line directly to the noisy data 900 as shown in FIG. 9A. The large variance of the line slopes is evident. Referring to FIG. 9B, next the described improved technique was used to estimate the underlying model. Lines were then fitted to the estimated model curves using a suitable line fitting technique. The lines 910 resulting from the 20 trials has a substantial reduction in slope estimation variance. This demonstrates that the technique delivers relatively stable results.

It may be desirable to remove or otherwise reduce the effects of non-specific binding. Non-specific binding occurs when compounds present in the solution containing the specific target modules also bind to the sensor despite the fact that surface functionalisation was designed for the target. Non-specific binding tends to proceed at a different rate than specific but also tends to follow a similar model, such as the Langmuir model, when concentrations are sufficient. Therefore, another single pole, due to non-specific binding, may be present within the impedance response curve.

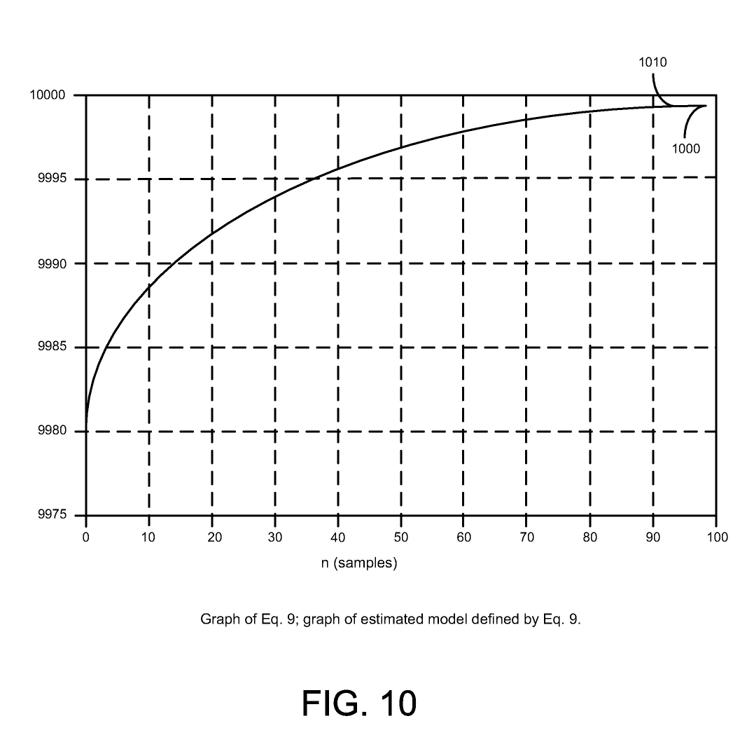

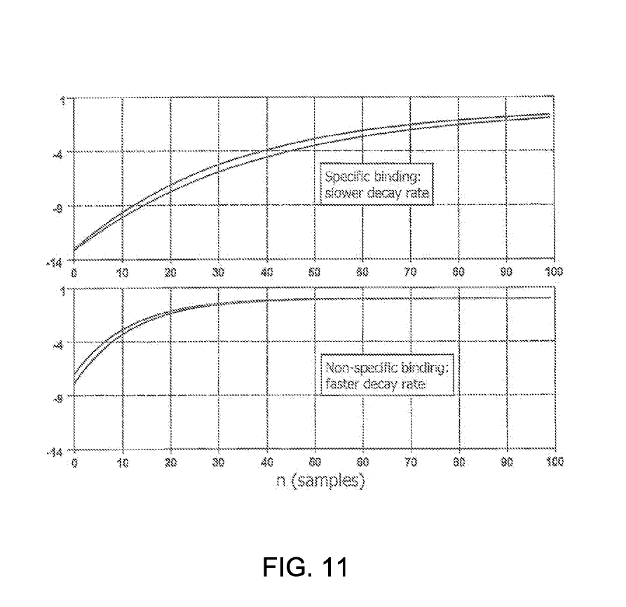

The modified KT technique has the ability to separate the component poles of a multi-pole signal This advantage may be carried over to the domain as illustrated in FIG. 10 and FIG. 11. Equation 9 describes an extended model that contains two non-trivial poles representing non-specific and specific binding responses (s₁<s₂), |Z|(n)=B−A₁e^{-s}^{₁}ⁿ−A₂e^{-s}^{₂₁}ⁿ where sₖ, Aₖ, B≧0 are constants (equation 9). Equation 9 is shown as a curve 1000 in FIG. 10 which is also close to the estimated model defined by equation 9.

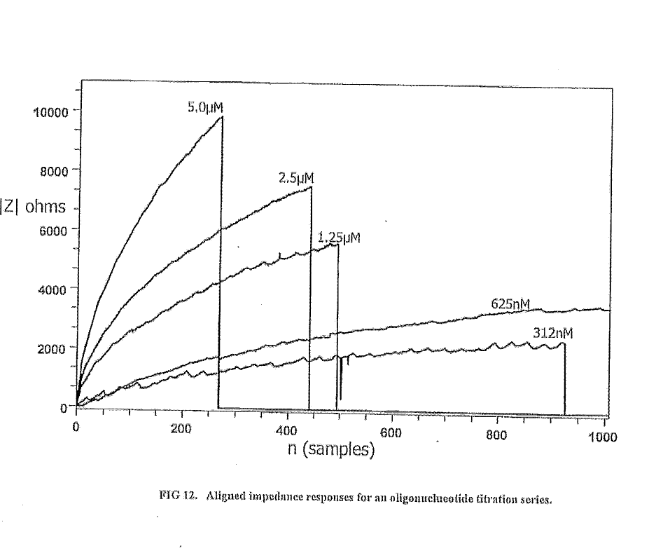

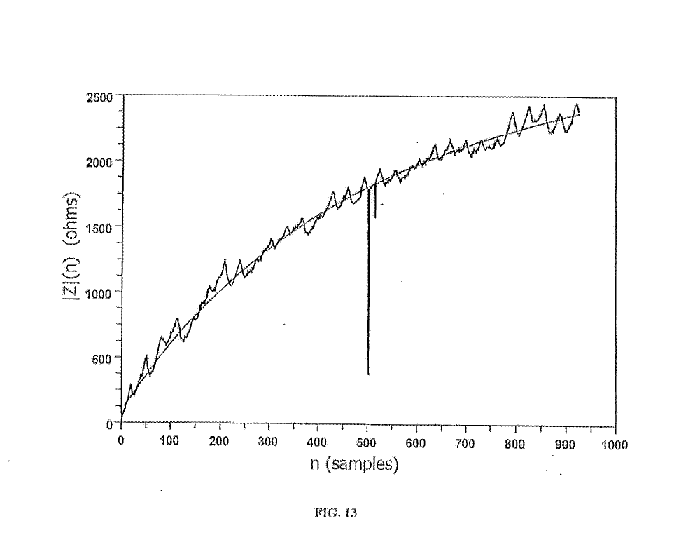

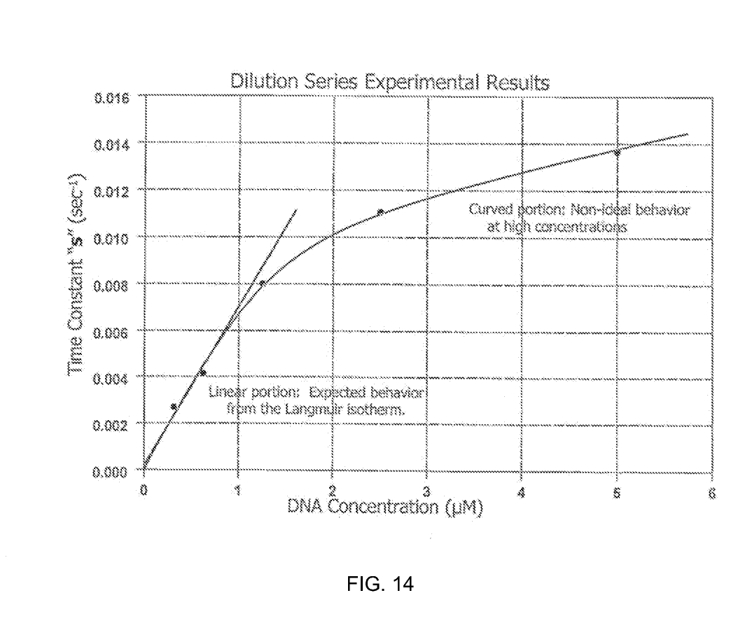

FIG. 12 illustrates the impedance responses of a titration series using oligonucleotide in PBST. The highest concentration used was 5 μM. The concentration was reduced by 50% for each successive dilution in the series. In FIG. 12, the five impedance responses have been aligned to a common origin for comparison. The meaning of the vertical axis, therefore, is impedance amplitude change from time of target injection. The response model was computed for each response individually using the disclosed estimation technique. FIG. 13 plots the lowest concentration (312.5 nM) response which also is the noisiest (s=0.002695 and A=1975.3). In addition, the estimated model curve is shown which fits the data. The results of the titration series evaluation are illustrated in FIG. 14, which at low concentrations shows a relationship close to the expected linear behavior between the decay rate and the actual concentration that is predicted by the Langmuir model. For high concentrations the estimates of rate depart from linearity. At these concentrations non-ideal behavior on the sensor surface is expected.

While decimation of the data may be useful to more readily identify the poles, this unfortunately results in a significant reduction in the amount of useful data thereby potentially reducing the accuracy of the results. Accordingly, it is desirable to reduce or otherwise eliminate the decimation of the data, while still being able to effectively distinguish the poles.

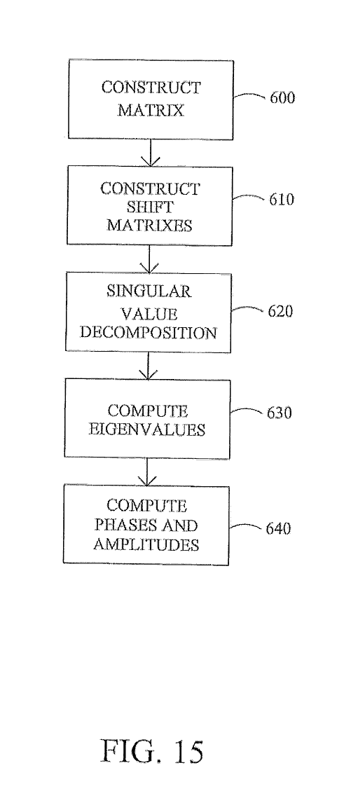

A different technique may be based upon a decimative spectral estimation. Referring to FIG. 15, the first step 600 is to construct a N−L+1×L Hankel signal observation matrix (denoted by S) of the deterministic signal of M exponentials from the N data points, where (N−D+1)/2<=L<N−M+1,and D is the decimation factor. The second step 610 includes constructing (N−L−D+1)×L matrices S^{D} (top D rows of S deleted) and S_{D} (bottom D rows of S deleted) equivalents, although in the presence of noise they are not necessarily equivalent to S. S^{D} and S_{D} are called “shift matrices”. The third step 620 includes computing a lower dimensional projection, S_{D,e} of S_{D} by performing a Singular Value Decompostion, S_{D}=UΣV, and then truncating to order M by retaining the largest M singular values. This process yields an enhanced version of S_{D} which substantially reduces the effect of the signal noise, and hence increases the accuracy of the pole estimates. The fourth step 630 includes computing matrix X=S^{D}pinv(S_{D,e}). The eigenvalues of X provide the decimated signal poles estimates, which in turn give the estimates for the damping factors and frequencies. The fifth step 640 includes computing the phases and the amplitudes. This may be performed by finding a least squares or total least squares solution, or other suitable technique. The derivation described above is for the noiseless case. In that case, the “small” singular and eigenvalues will be zero. With the addition of noise, such values are generally small.

As previously discussed, the impedance response signal is derived from the v(t) and i(t) signals. The impedance response signal may be analyzed into two (or more) unconstrained signal poles, namely, S₀ and S₁. S₀ is a pole on the unit circle which is a DC pole and S₁ is a pole off the unit circle. The phase and amplitude associated with each pole is then estimated.

The two unconstrained poles tend to be very close to one another. When the DC pole (S₀) includes an estimation error (from noise in the impedance signal), its proximity to the non-DC pole (S₁) induces a significant error into the latter, which in turn, induces an error into its associated complex amplitude estimate A₁. This inducement of error reduces the accuracy of the system.

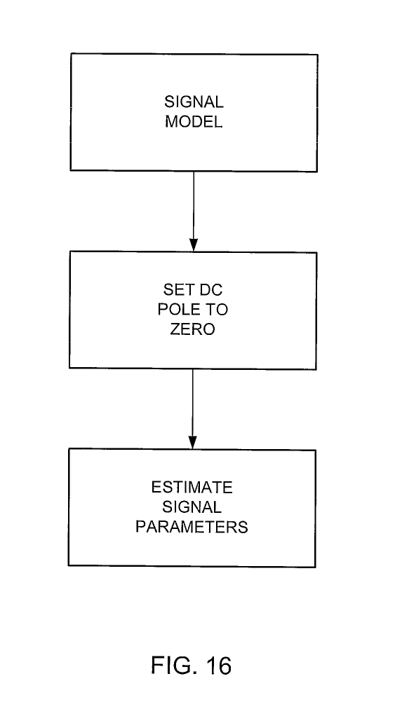

Referring to FIG. 16, based upon the signal model, a-priori knowledge exists of the DC pole, namely, that S₀=0. By using an estimation technique that allows incorporation of a-priori knowledge a constraint can be imposed so that its value is set to zero and not estimated. One suitable technique may be Constrained Henkel Singular Value Decomposition. Consequently, the influence of errors in S₀ may be removed on the estimated parameters S₁ and A₁, where A₁ is the complex amplitude associated with S₁.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I/We claim:

1. A method for calculating parameters comprising:
(a) receiving a time varying voltage signal associated with a biosensor;
(b) receiving a time varying current signal associated with said biosensor;
(c) transforming said time varying voltage signal and said time varying current signal to a domain that represents complex impedance values;
(d) calculating parameters based upon said impedance values using at least one constrained pole set to a DC value.

2. The method of claim 1 wherein said one constrained pole is a pole on a unit circle.

3. The method of claim 1 wherein calculating parameters is based upon another signal pole.

4. The method of claim 3 wherein said another signal pole is a pole off a unit circle.

5. The method of claim 4 wherein said another signal pole has an associated phase and amplitude.

6. The method of claim 1 wherein said one constrained pole is constrained based upon a-priori knowledge.

7. The method of claim 1 wherein said calculating parameters is based upon a Constrained Hankel Singular Value Decomposition.
